(19) United States
(12) Patent Application Publication
(10) Pub. No.: US 2004/0079182 A1
(43) Pub. Date: Apr. 29, 2004

(54) Reversing device for a remote-controlled vehicle

(76) Inventor: Daimler Chu, Taipei (TW)

Correspondence Address: Daimler Chu, PO Box 82-144, Taipei, TW

(21) Appl. No.: 10/281,169

(22) Filed: Oct. 28, 2002

(51) Int. Cl. F16H 3/14

(52) U.S. Cl. 74/355

(57) ABSTRACT

An improvement of a reversing device for a remote-controlled vehicle is disclosed. The reversing device comprises the driving wheel (10) is connected to a worm gear (11), and the center of the driving wheel (10) and the worm gear (11) is provided with a shaft hole (13) having a braking structure at the lateral side of the shaft hole (13); the clutch blade (40) and the axle (60) are connected together as one unit such that the axle passes through the driving wheel (10) and the driven gears (20); the triggering rod (50) is connected to a switching rod (51) which is mounted at the upper section of the clutch blade (40); thereby two transmission worm gears (30, 30a) are used to connect the engagement of the worm gear (11) and the driven gear (20), under normal condition, the clutch blade (40) is in contact with the worm gear (11) connected to the lateral side of the driving wheel (10), such that when the triggering rod (50) moves, the switching rod (51) drives the clutch blade (40) to move horizontally, if the clutch blade is dislocated from the driving wheel and is connected to the driven worm gear (20), a reverse rotation is obtained.

### BACKGROUND OF THE INVENTION

(a) Technical Field of the Invention

The present invention relates to an improvement of a reversing device for a remote-controlled vehicle, and in particular, a device which can control the backward and forward movement of a remote-controlled toy vehicle by switching the clutch blade using a triggering rod.

(b) Description of the Prior Art

Common remote-controlled toy vehicle can move either forward or backward by means of a motor. Taiwanese Patent Publication No. 481036, entitled “Forward and reversing control device of a toy vehicle” discloses the structure comprising a transmission shaft, a first fixing gear, a second fixing gear, a moveable gear, a first inert gear, a second inert gear and a servo. The actuation of the servo controls the moving gear to move along the transmission shaft. The moving gear can engage with the first or the second fixing gear so as to control the reversing of the toy vehicle.

However, the components constituted the structure are numerous and the installation of all the components is laborious and troublesome. Accordingly, it is an object of the present invention to provide an improvement of a reversing device for a remote-controlled vehicle, so as to overcome the above drawbacks.

### SUMMARY OF THE INVENTION

An object of the present invention is to provide An improvement of a reversing device for a remote controlled vehicle having a driven wheel (10), driven worm gears (20), a triggering rod (50), an axle (60) and clutch blade (40), wherein the driving wheel (10) is connected to a worm gear (11), and the center of the driving wheel (10) and the worm gear (11) is provided with a shaft hole (13) having a braking structure at the lateral side of the shaft hole (13); the clutch blade (40) and the axle (60) are connected together as one unit such that the axle passes through the driving wheel (10) and the driven gears (20); the triggering rod (50) is connected to a switching rod (51) which is mounted at the upper section of the clutch blade (40); thereby two transmission worm gears (30, 30a) are used to connect the engagement of the worm gear (11) and the driven gear (20), under normal condition, the clutch blade (40) is in contact with the worm gear (11) connected to the lateral side of the driving wheel (10), such that when the triggering rod (50) moves, the switching rod (51) drives the clutch blade (40) to move horizontally, if the clutch blade is dislocated from the driving wheel and is connected to the driven worm gear (20), a reverse rotation is obtained.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded perspective view showing the components of the present invention.

FIG. 3 is a sectional view of the present invention, under normal operating condition.

FIG. 4 is a sectional view of the switching to vehicle-reversing in accordance with the present invention.

FIG. 5 is an exploded perspective view of another preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

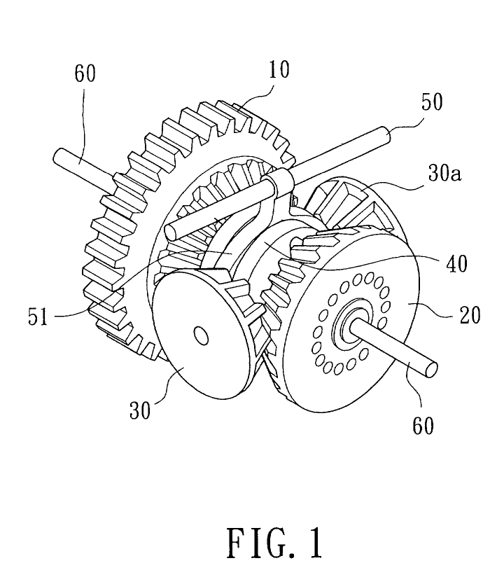

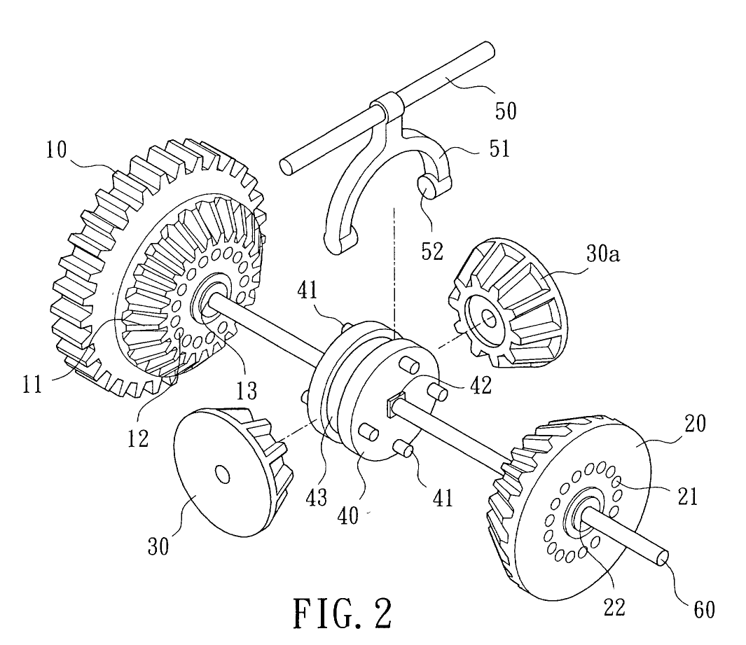

Referring to FIGS. 1 and 2, there is shown an improvement of a reversing device for a remote-controlled vehicle, comprising a driving wheel 10, driven worm gears 20, worm gears 30, 30a, clutch blade 40, a triggering rod 50, a switching rod 51 and an axle 60 connected to the clutch blade 40, wherein the driving wheel 10 is provided with a shaft hole 13 at the center thereof and one lateral side of the wheel 10 is a plurality of concentric worm gear 11. The top face of the worm gear 11 is surrounded with a row of braking holes 12.

The two worm gears 30, 30a have same number of teeth and diameter size and are mounted between the driving wheel 10 and the driven worm gear 20. By means of transmission of the two worm gears 30, 30a, the rotating direction of the driven worm gear 20 is opposite to that of the driving wheel 10. The size and the teeth number of the driven worm gear 20 are similar to that of the driving wheel 10 mounted with the worm gear 11. The center of the driven worm gear 20 is provided with the shaft hole 22. The lateral side of the shaft hole 22 is surrounded by a row of braking holes 21, and the braking hole 21 thereof is similar in size to that of the braking hole 12, which allows the insertion of the braking block 41 of the clutch blade 40.

The clutch blade 40 is a disc body and the two lateral side flat faces are provided with a plurality of braking blocks 41. The circle center region 42 facing the lateral side is provided with an axle 60. The clutch blade 40 is radially provided with a recess 43.

The reversing switching element is provided with a triggering rod 50. The end terminal of the rod is mounted to a switching rod. The switching rod 51 is formed into an arch-shape to match with the clutch blade 40. At the same time, the two ends of the switching rod 51 are provided with a resisting block 52.

The axle 60 is mounted to the center circle region 42 of the clutch blade 40. The diameter thereof is smaller than the internal diameter of the shaft hole 13 of the driving wheel 10 and the internal diameter of the shaft hole 22 of the driven worm gear 20, such that the axle 60 passes there through.

Referring to FIG. 2, the axle 60 passes through the shaft hole 13 of the driving wheel 10, and the shaft hole 22 of the driven worm gear 20 such that the two components and the axle 60 are combined loosely. The two worm gears 30, 30a are mounted respectively at the front and rear side of the clutch blade 40, and are engaged with the driven worm gear 20 and the worm gear 11 of the driving wheel 10. The triggering rod 50 is perpendicular to the axle 60 and the switching rod 51 of the triggering rod 50 is in engagement with the recess 43 of the clutch blade 40. The resisting block 52 at the two ends of the switching rod 51 is engaged at the recess 43. Thus, the reversing device is obtained.

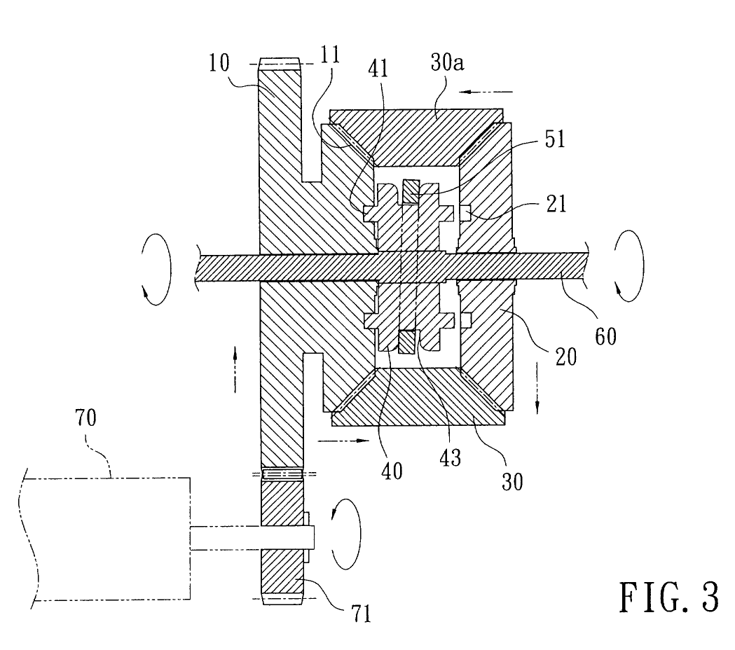

Referring to FIG. 3, one end of the axle 60 is connected to the driving right wheel and one end is connected to the driving left wheel. The driving wheel 11 and the gear 70 of the motor 70 are in engagement. Under normal condition, the triggering rod 50 is biased to the left side such that the switching rod 51 causes the clutch blade 40 to resist at the driving wheel 10 at the left side, and the braking block 41 of the braking blade 40 urges the braking hole 12 of the worm gear 11.

When a forward motion is controlled remotely, the motor 70 starts to rotate to drive the driving wheel 10 in clockwise. The worm gear 11 engaged with the driving wheel 10 rotates clockwise. Due to the fact that the braking block 41 is engaged with the braking hole 12 of the worm gear 11, the axle 60 and the driving wheel 10 rotate clockwise.

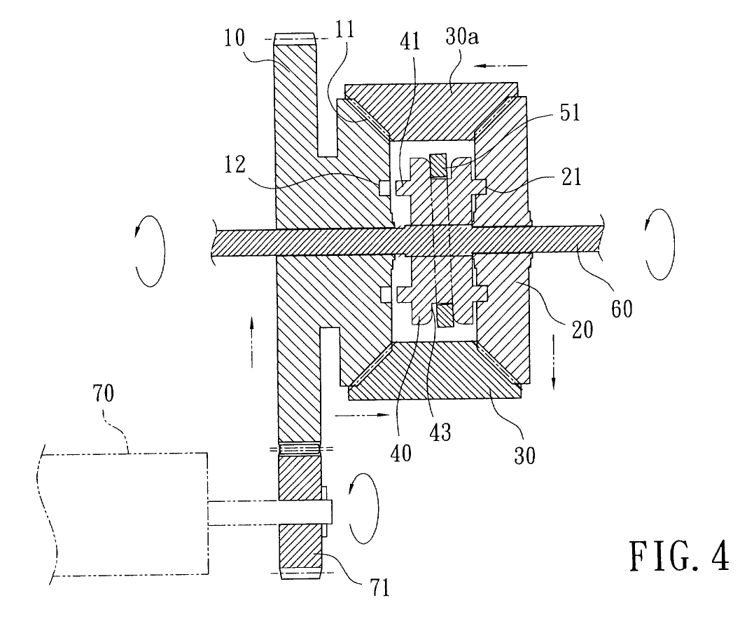

Referring to FIG. 4, when a reverse direction is to be performed, the triggering rod 50 is triggered to the right side and the switching rod 51 causes the clutch blade 40 to urge the side of the worm gear 20 such that the braking block 41 is engaged at the braking hole 21 of the worm gear 20. The axle 60 and the driven worm gear 20 rotate in a same direction, at the same time, the gear 71 rotates anticlockwise. The clutch blade 40 is engaged with the driven worm gear 20. The entire structure can provide directional change by means of the worm gear 30 and 30a, and the driven worm gear 20 rotates anticlockwise. Thus, the toy vehicle can move in a reverse direction.

The motor 70 rotates at a specific direction such that no power loss when the direction of rotating is changed.

By means of the appropriate combination of the worm gear, the rotation of the gear allows a forward or a reversing direction is controlled.

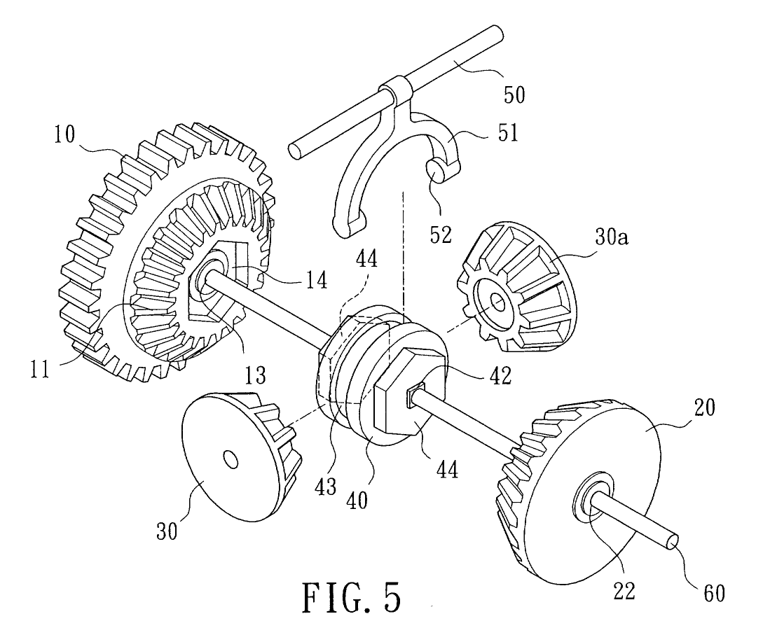

Referring to FIG. 5, the side of the driving wheel 10 is provided with concentric worm gear 11 and the top face of the worm gear 11 is provided with braking mechanism so as to provide greater torque value. The braking hole 12 can be altered into multiple shaped recess 14 to engage with multiple cornered protruded block 44. Thus, a high anti-stress structure is obtained.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improvement of a reversing device for a remote controlled vehicle having a driven wheel (10), driven worm gears (20), a triggering rod (50), an axle (60) and clutch blade (40), wherein the driving wheel (10) is connected to a worm gear (11), and the center of the driving wheel (10) and the worm gear (11) is provided with a shaft hole (13) having a braking structure at the lateral side of the shaft hole (13); the clutch blade (40) and the axle (60) are connected together as one unit such that the axle passes through the driving wheel (10) and the driven gears (20); the triggering rod (50) is connected to a switching rod (51) which is mounted at the upper section of the clutch blade (40); thereby two transmission worm gears (30, 30a) are used to connect the engagement of the worm gear (11) and the driven gear (20), under normal condition, the clutch blade (40) is in contact with the worm gear (11) connected to the lateral side of the driving wheel (10), such that when the triggering rod (50) moves, the switching rod (5 1) drives the clutch blade (40) to move horizontally, if the clutch blade is dislocated from the driving wheel and is connected to the driven worm gear (20), a reverse rotation is obtained.

2. The reversing device of claim 1, wherein one side of the driving wheel (10) is mounted with a worm gear (11), and the lateral side of the center shaft hole of the worm gear (11) is mounted with braking structure, which is a plurality of braking holes and the two end faces of the clutch blade (40) are provided with a plurality of braking blocks for engaging such that the braking blocks (41) are in engagement with the braking holes.

3. The reversing device of claim 1, wherein one side of the driving wheel (10) is mounted with a worm gear (11), and the lateral side of the center shaft hole of the worm gear (11) is mounted with braking structure, which is recess of polygonal shape, and the two end faces of the clutch blade are provided with polygonal protruded blocks, and the protruded blocks are in engagement with the recess.

4. The reversing device of claim 1, wherein the size and the number of teeth of the driven worm gear (20) are the same as that of the worm gear (11) connected to the driving wheel.

5. The reversing device of claim 1, wherein the size and the number of the two worm gears (30, 30a) connecting the driving wheel and the driven worm gear are the same.

6. The reversing device of claim 1, wherein the clutch blade is radially provided with recess such that the triggering rod is engageable with the recess and is controlled to move by the switching rod.

7. The reversing device of claim 1, wherein the axle and the driving wheel with the driven worm gear (20) are loosely connected.
